(19) United States
(12) Patent Application Publication
(10) Pub. No.: US 2015/0178527 A1
(43) Pub. Date: Jun. 25, 2015

(54) RFID TAG ISSUING DEVICE

(71) Applicant: TOSHIBA TEC KABUSHIKI KAISHA, Tokyo (JP)

(72) Inventors: Nobuo MUROFUSHI, Susono Shizuoka (JP); Wataru SAKURAI, Izu Shizuoka (JP)

(21) Appl. No.: 14/580,586

(22) Filed: Dec. 23, 2014

(30) Foreign Application Priority Data
Dec. 25, 2013 (JP) 2013-267981

(51) Int. Cl. G06K 7/10

(52) U.S. Cl. CPC G06K 7/10316; G06K 7/10346

(57) ABSTRACT

An RFID tag issuing device includes a guide member extending in a first plane along which an RFID tag is guided, an antenna substrate having a surface forming a second plane that is not parallel to the first plane and an antenna disposed on the surface to emit a signal towards the RFID tag, and a signal processor configured to generate the signal to be emitted from the antenna.

### CROSS-REFERENCE TO RELATED APPLICATION

This application is based upon and claims the benefit of priority from Japanese Patent Application No. 2013-267981, filed Dec. 25, 2013, the entire contents of which are incorporated herein by reference.

### FIELD

Embodiments described herein relate generally to an RFID tag issuing device that issues an RFID (Radio Frequency Identification) tag.

### BACKGROUND

Conventionally, as an RFID tag issuing device, a label printer including a thermal head which performs printing on a label including an RFID tag and a reader and writer which reads and writes data from and to the RFID tag in the label.

### DESCRIPTION OF THE DRAWINGS

FIG. 1 is a schematic diagram of an RFID tag issuing device according to a first embodiment.

FIG. 2 is a perspective plane view of the RFID tag issuing device according to the first embodiment.

FIG. 3 is a cross-sectional view of a base ribbon used in the RFID tag issuing device according to the first embodiment.

FIG. 4 is a schematic diagram of an antenna substrate of the RFID tag issuing device according to the first embodiment.

FIG. 5 is a block diagram of a control system of the RFID tag issuing device according to the first embodiment.

FIG. 6 is a schematic diagram illustrating an antenna substrate according to a second embodiment.

### DETAILED DESCRIPTION

The conventional reader and writer of the label printer includes an antenna substrate disposed in a plane parallel to a transport surface of the label, and thereby it is difficult to reduce the size of the label printer.

Upon such drawbacks of the conventional RFID tag issuing device, an RFID tag issuing device that has a small size and can perform reliable read and write operation of data is desired.

In general, according to one embodiment, an RFID tag issuing device includes a guide member extending in a first plane along which an RFID tag is guided, an antenna substrate having a surface forming a second plane that is not parallel to the first plane and an antenna disposed on the surface to emit a signal towards the RFID tag, and a signal processor configured to generate the signal to be emitted from the antenna.

Hereinafter, exemplary embodiments will be described in detail with reference to the drawings.

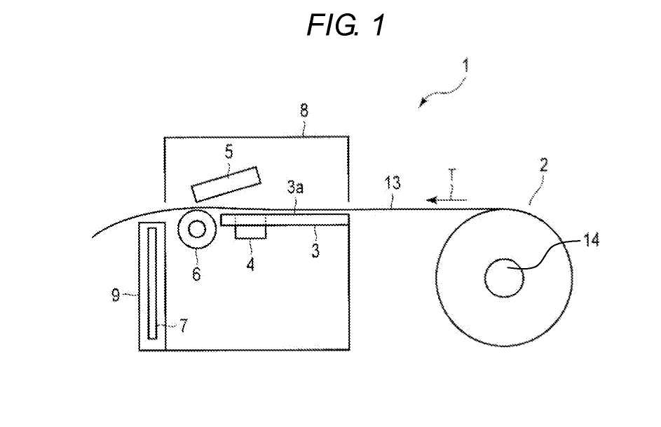

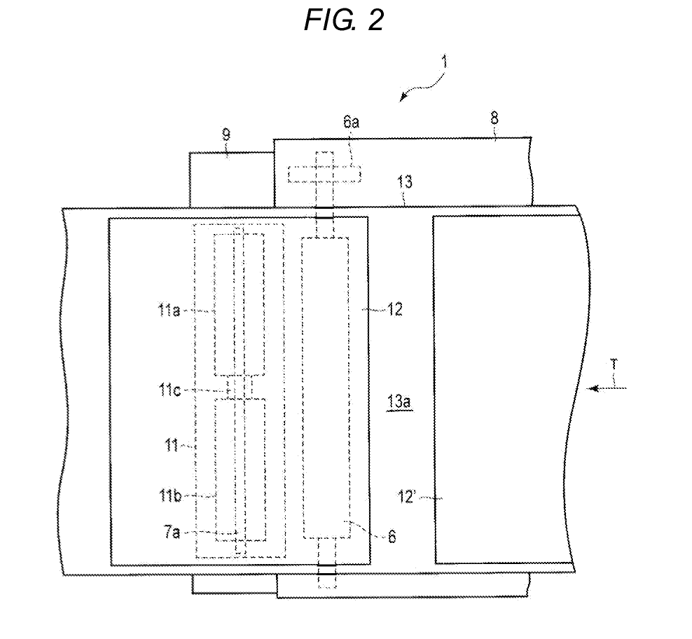

FIG. 1 is a schematic diagram of an RFID tag issuing device 1 (hereinafter, simply referred to as an issuing device 1) according to a first embodiment as seen from the front. FIG. 2 is a perspective plan view of the issuing device 1 as seen from the above.

As shown in FIG. 1, the issuing device 1 includes a ribbon supply unit 2, a guide plate 3, a label sensor 4, a thermal head 5, a platen roller 6, an antenna substrate 7, and a housing 8. In the first embodiment, the antenna substrate 7 is disposed in a case 9, which is separately attached to the outside of the housing 8. Alternatively, the antenna substrate 7 may be disposed in the housing 8 without the case 9.

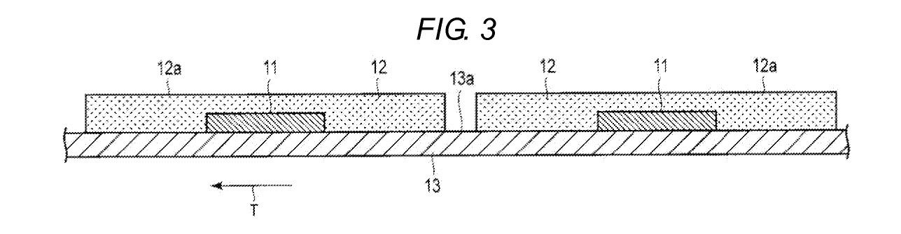

The ribbon supply unit 2 continuously conveys a base ribbon 13 wound around a roller 14 in a conveying direction (direction T shown by an arrow in FIG. 1). As illustrated in FIG. 2 and FIG. 3 in detail, the base ribbon 13 has a plurality of labels 12 (media), each of which includes an RFID tag 11, arranged side by side on a surface 13a of the base ribbon 13 in a longitudinal direction (i.e., the conveying direction).

Each of the labels 12 has a width slightly shorter than a width of the base ribbon 13 in a direction orthogonal to the conveying direction T. In addition, the labels 12 are attached on the surface 13a separately from one another in the conveying direction T. The label 12 is discharged from the issuing device 1 and then detached from the surface 13a of the base ribbon 13 so as to be attached to another product. In this case, the RFID tag 11 is attached to another product together with the label 12 by being detached from the base ribbon 13.

The RFID tag 11 is provided in the center of the label 12 along the conveying direction T. A variety of information can be printed on the surface 12a of the label 12 via the thermal head 5. For this reason, the RFID tag 11 is provided on the side of the surface 13a of the base ribbon 13 so as not to be exposed to the surface 12a of the label 12.

The RFID tag 11 includes two antennas 11a and 11b and an IC chip 11c which is connected between these two antennas 11a and 11b. The IC chip 11c functions as a transmitter and receiver 11c (FIG. 5) for transmitting and receiving various items of data to and from the antenna substrate 7 of the issuing device 1 via the two antennas 11a and 11b. Hereinafter, the IC chip 11c may be referred to as the transmitter and receiver 11c in some cases.

The guide plate 3 includes a flat upper surface 3a which guides the side of a rear surface 13b of the base ribbon 13 conveyed from the ribbon supply unit 2 into the housing 8. The guide plate 3 is fixed in the housing 8 with the upper surface 3a being substantially horizontal. A surface including the upper surface 3a of the guide plate 3 functions as a guide surface to guide the conveyed base ribbon 13.

The label sensor 4 detects the labels 12 attached on the base ribbon 13 which is conveyed along the aforementioned guide surface 3a in the conveying direction T. Then, the label sensor 4 obtains information on a transport position of each the label 12. The information obtained through the label sensor 4 is transported to a controller 20 of the issuing device 1 (FIG. 5).

The thermal head 5 is disposed close to a downstream side of the guide plate 3 in the conveying direction T of the base ribbon 13 and faces the guide surface 3a. The platen roller 6 is positioned to face the thermal head 5 across the guide surface 3a. The thermal head 5 and the platen roller 6 are components of a printing unit 28 (FIG. 5).

The platen roller 6 extends in the width direction of the label 12, which is orthogonal to the conveying direction T. In an end of a rotating shaft of the platen roller 6, a gear 6a is provided to transmit a driving force generated by a driving unit 22 (FIG. 5) to the platen roller 6.

An ink ribbon (not shown) is interposed between the thermal head 5 and the base ribbon 13. The ink ribbon travels in the same direction and at the same speed as the base ribbon 13. The thermal head 5 is movably provided toward the platen roller 6 so as to press the ink ribbon against the label 12 attached on the base ribbon 13.

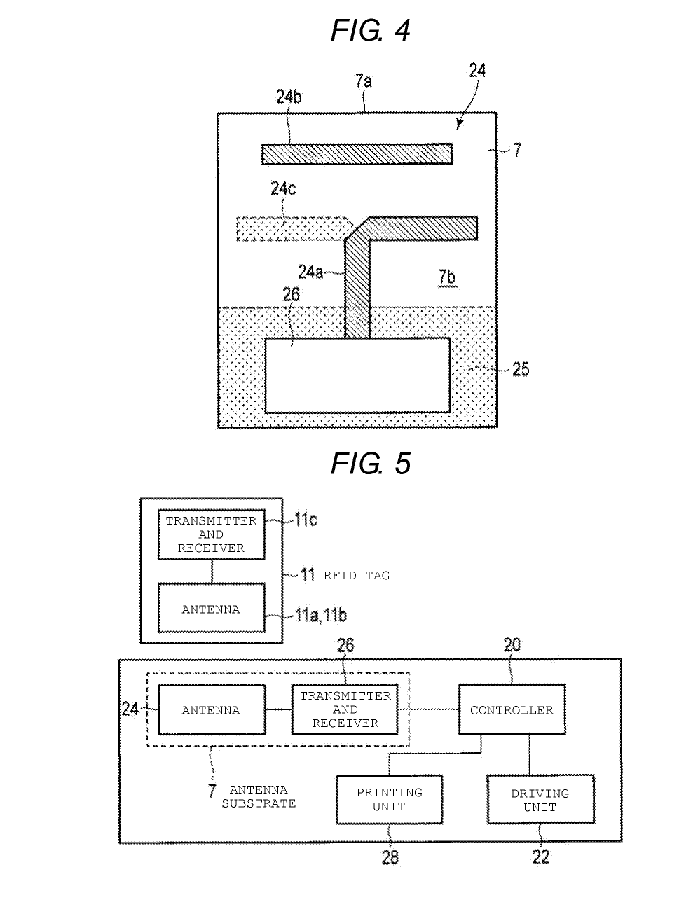

FIG. 4 is a schematic diagram of the antenna substrate 7 according to the first embodiment.

The antenna substrate 7 is, as shown in FIG. 1, disposed in the case 9 along a gravity direction, which is substantially orthogonal to the conveying direction T of the base ribbon 13 and to the guide surface 3a. The antenna substrate 7 is provided downstream with respect to the platen roller 6 in the conveying direction T and outside the housing 8. An upper end 7a (an edge portion) facing the guide surface 3a of the antenna substrate 7 extends, as shown in FIG. 2, along the width direction of the label 12.

As shown in FIG. 4, the antenna substrate 7 has a print pattern of an antenna 24 on both surfaces thereof. That is, a dipole antenna 24a and a passive element 24b are disposed on one surface 7b of the antenna substrate 7. On the other surface of the antenna substrate 7, a dipole antenna 24c and a ground pattern 25 are disposed. The ground pattern 25 is provided on a lower part of the antenna substrate 7, which is apart from the guide surface 3a. In addition, an IC chip which functions as a transmitter and receiver 26 is mounted on a region of the antenna substrate 7 where the surface 7b of the antenna substrate 7 overlaps with the ground pattern 25. Hereinafter, the transmitter and receiver 26 may be referred to as an IC chip 26 in some cases.

The two dipole antennas 24a and 24c which are provided on both surfaces of the antenna substrate 7 extend vertically upward from the transmitter and receiver 26 and, in the middle of the extension, are curved at a substantially right angle and extend along a front surface of the antenna substrate 7 in the mutually reverse directions. The passive element 24b is disposed at a position above the dipole antennas 24a and 24c, and is parallel to the portion of the two dipole antennas 24a and 24c that extend in the reverse directions. That is, the passive element 24b is provided between the two dipole antennas 24a and 24c and the upper end 7a of the antenna substrate 7.

According to the first embodiment, by disposing the passive element 24b in the vicinity of the upper end 7a of the antenna substrate 7, it is possible for radio waves generated by the antenna 24 to have directivity toward the guide surface 3a from the upper end 7a of the antenna substrate 7. With this configuration in which the antenna substrate 7 is disposed substantially perpendicular to the guide surface 3a, it is possible to favorably transmit and receive the various items of data to and from the RFID tag 11.

FIG. 5 is a block diagram of a control system controlling an operation of the issuing device 1.

The controller 20 for controlling the operation of the issuing device 1 is connected to the transmitter and receiver 26 of the antenna substrate 7 and the thermal head 5 of the printing unit 28 in addition to the driving unit 22. In addition, although the drawing is not shown, the label sensor 4 is connected to the controller 20.

The base ribbon 13 is caused to travel in accordance with the operation of the driving unit 22 controlled by the controller 20. Then, the controller 20 controls the label sensor to detect the transport position of each label 12 which is attached on the base ribbon 13. The controller 20 drives the thermal head 5 based on a detection result in a timely manner so as to print a variety of information on the surface 12a of each of the labels 12.

Further, the controller 20 controls the transmitter and receiver 26 of the antenna substrate 7 to transmit and receive the data to and from the transmitter and receiver 11c of the RFID tag 11 of the label 12 that is conveyed so that the various items of data is written in the IC chip 11c of the RFID tag 11.

As described above, according to the first embodiment, the antenna substrate 7 of the issuing device 1 is disposed substantially perpendicular to the guide surface 3a of the RFID tag 11, and thus it is possible to decrease the size of the device along the conveying direction T.

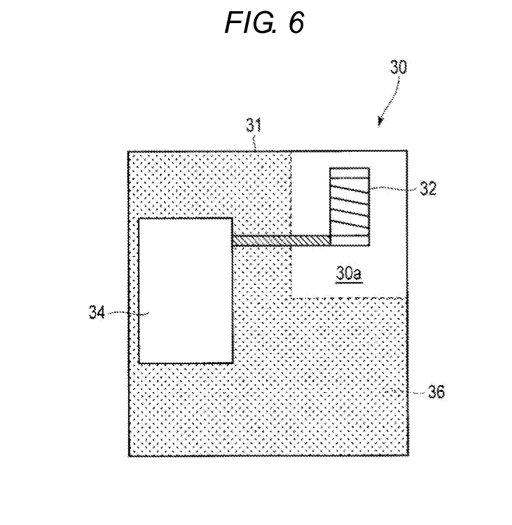

FIG. 6 is a schematic diagram of an antenna substrate 30 of an RFID tag issuing device according to a second embodiment.

The antenna substrate 30 includes a chip antenna 32 in the vicinity of an upper corner portion on one surface 30a thereof. In addition, a transmitter and receiver 34 (IC chip 34) connected to the chip antenna 32 is disposed on the surface 30a.

On the other hand, a ground pattern 36 is provided on the other surface of the antenna substrate 30. The ground pattern 36 is disposed on the almost entire surface of the antenna substrate 30 except for an area corresponding to the chip antenna 32 and an area therearound.

Similar to the antenna substrate 7 according to the first embodiment, the antenna substrate 30 includes the upper end 31 that faces the guide surface 3a and that is orthogonal to the conveying direction T of the RFID tag 11 and along the vertical direction.

In other words, when the antenna substrate 30 of the second embodiment is used, the same or similar effect as in the first embodiment may be obtained; and as a result it is possible to decrease the size of the issuing device and improve the read and write performance of data.

When the antenna substrate 30 of the second embodiment is used, it is preferable that a mounted position of the IC chip 34 with respect to the antenna substrate 30 be laid out so that the IC chip 34 is close to the gear 6a of the platen roller 6. With this configuration, it is possible to dispose the IC chip 34 by effectively utilizing spaces for disposition of the gear 6a, thereby preventing the size of the issuing device from increasing.

According to at least one of the embodiments as described above, since the antenna substrate is disposed perpendicular to the guide surface of the RFID tag, it is possible to decrease the size of the issuing device, thereby improving the read and write performance of data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the above-described embodiments, the upper ends 7a and 31 of the antenna substrates 7 and 30 extend in the width direction orthogonal to the conveying direction T, but the embodiments are not limited to this case. The antenna substrates 7 and 30 may be inclined with respect to the conveying direction T.

What is claimed is:

1. An RFID tag issuing device comprising:
a guide member extending in a first plane along which an RFID tag is guided;
an antenna substrate having a surface forming a second plane that is not parallel to the first plane and an antenna disposed on the surface to emit a signal towards the RFID tag; and
a signal processor configured to generate the signal to be emitted from the antenna.

2. The RFID tag issuing device according to claim 1, wherein the antenna substrate has another surface forming a third plane parallel to the second plane, and the antenna is printed on both surfaces.

3. The RFID tag issuing device according to claim 1, wherein the antenna is printed on the surface.

4. The RFID tag issuing device according to claim 3, wherein
the antenna substrate includes an end surface extending in a direction that is parallel to the direction in which the RFID tag is guided.

5. The RFID tag issuing device according to claim 4, wherein
the antenna includes a dipole antenna and a passive element.

6. The RFID tag issuing device according to claim 5, wherein
the passive element is disposed between the dipole antenna and the end surface of the antenna substrate.

7. The RFID tag issuing device according to claim 4, wherein
the antenna includes a chip antenna.

8. The RFID tag issuing device according to claim 7, wherein
the chip antenna is disposed on a region of the antenna substrate that is closer to the end surface than an opposite end surface of the antenna substrate.

9. The RFID tag issuing device according to claim 1, wherein
the signal processor is disposed on the antenna substrate.

10. The RFID tag issuing device according to claim 1, further comprising:
a housing in which the guide member is included, wherein
the antenna is disposed outside the housing along surface thereof.

11. The RFID tag issuing device according to claim 1, further comprising:
a printing unit configured to print an image on a surface of the RFID tag, wherein
the RFID tag having the printed image is guided towards the antenna.

12. A method for communicating data between an RFID tag and an antenna, the method comprising:
conveying an RFID tag along a first plane;
generating a signal; and
transmitting the signal from an antenna towards the RFID tag, the antenna being disposed on a surface of an antenna substrate that extends in a second plane that is not parallel to the first plane.

13. The method according to claim 12, wherein the antenna is printed on the surface.

14. The method according to claim 12, wherein
the antenna substrate has another surface forming a third plane that is parallel to the second plane, and the antenna is printed on both surfaces.

15. The method according to claim 12, wherein
the antenna includes a dipole antenna and a passive element.

16. The method according to claim 15, wherein
the passive element is disposed between the dipole antenna and the RFID tag.

17. The method according to claim 12, wherein
the antenna includes a chip antenna.

18. The method according to claim 12, further comprising:
printing an image on a surface of the RFID tag, wherein
a signal is transmitted from the antenna towards the RFID tag having the image.
